(19) United States
(12) Patent Application Publication
(10) Pub. No.: US 2003/0116416 A1
(43) Pub. Date: Jun. 26, 2003

(54) Steering-column assembly function unit and method of using and making same

(76) Inventor: Peter Wieltsch, Boeblingen (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/303,068

(22) Filed: Nov. 25, 2002

(30) Foreign Application Priority Data
Nov. 24, 2001 (DE) DE 101 57 716.8

(51) Int. Cl. H01H 3/16

(52) U.S. Cl. 200/61.27

(57) ABSTRACT

A steering-column assembly function unit for a motor vehicle has a setting lever which can be held via a bearing unit in a first initial position, from which the setting lever can be actuated for control. The setting lever is capable of being held via the bearing unit in at least one second initial position, from which the setting lever can be actuated for control, the first initial position being assigned to a parameter selection and the second initial position to a system selection.

### BACKGROUND AND SUMMARY OF THE INVENTION

This application claims the priority of German Patent Document 101 57 716.8, filed on Nov. 24, 2001, the disclosure of which is expressly incorporated by reference herein.

The invention relates to a steering-column assembly function unit comprising a setting lever which can be held via a bearing unit in a first initial position, from which the setting lever can be actuated for control.

A steering-column assembly function unit for a motor vehicle, with a setting lever for controlling a cruise control system and for controlling a variable speed-limiting system, is known. The setting lever is held via a bearing unit in an initial position, from which the setting lever can be pivoted or tipped in four directions for control, specifically upwards and downwards in and opposite to the direction of travel and in the circumferential direction of a steering wheel, the setting lever always being reset automatically into its initial position after actuation. For the change-over between the systems, the setting lever is tipped into its direction of axial extent.

An aspect on which certain preferred embodiments of the invention are based is to provide a generic steering-column assembly function unit in which numerous systems can be controlled simply and in an easily understandable way via a setting lever. This is achieved, according to certain preferred embodiments of the invention, bin that the setting lever can be held via the bearing unit in at least one second initial position, from which the setting lever can be actuated for control, the first initial position being assigned to a parameter selection and the second initial position to a system selection. Further refinements may be gathered from below and other embodiments.

Proceeding from a steering-column assembly function unit for a motor vehicle, which has a setting lever which can be held via a bearing unit in a first initial position, from which the setting lever can be actuated for control, the setting lever is capable of being held via the bearing unit in at least one second initial position, from which the setting lever can be actuated for control, the first initial position being assigned to a parameter selection and the second initial position to a system selection. By virtue of the separation between system selection and parameter selection, numerous systems can be controlled simply and in an easily understandable way via one setting lever which, moreover, can be designed in a structurally simple way and cost-effectively. Furthermore, proven menu structures familiar to an operator can be set up. Via the setting lever, various systems which seem appropriate to a person skilled in the art can be controlled, but advantageously, systems for controlling and regulating the speed of the motor vehicle and a distance from another motor vehicle, such as, for example, a cruise control system, a speed-limiting system, etc.

The setting lever can be designed so as to be capable of being changed over between the initial positions in various directions, such as, for example, in a direction of rotation about its longitudinal axis, in the direction of its extent or in its longitudinal direction, etc. If, however, the setting lever is capable of being changed over at its free end between the initial positions basically perpendicularly to the direction of its extent and, in particular, in the longitudinal direction of the motor vehicle, particularly convenient operation can be achieved. For this purpose, the setting lever can be mounted in the bearing unit translationally or, advantageously, pivotably.

In a further refinement, it is envisioned that the first initial position be arranged so as to face an operator and the second initial position be arranged so as to face away from the operator. If a system is selected, the parameters can conveniently be set in the near-operator region.

Furthermore, the setting lever can be held in the initial positions via the bearing unit by a latching mechanism. Via the latching mechanism, it is possible advantageously to signal that an initial position is reached, with the result that maloperations can be avoided. An undesirable release from the selected initial position can be avoided.

If the setting lever is coupled to a signal unit and at least one initial position can be signalled via the signal unit, operation, in turn, can be simplified and maloperations can be avoided. The signal unit may be designed with a visual output unit, for example with a signal light or display, and/or with an acoustic output unit.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a diagrammatically illustrated steering-column assembly function unit in a motor vehicle,

FIG. 2 shows the steering-column assembly function unit from FIG. 1 in a top view,

FIG. 3 shows an enlarged detail III from FIG. 2, and

FIG. 4 shows a system and parameter matrix.

### DETAILED DESCRIPTION OF THE DRAWINGS

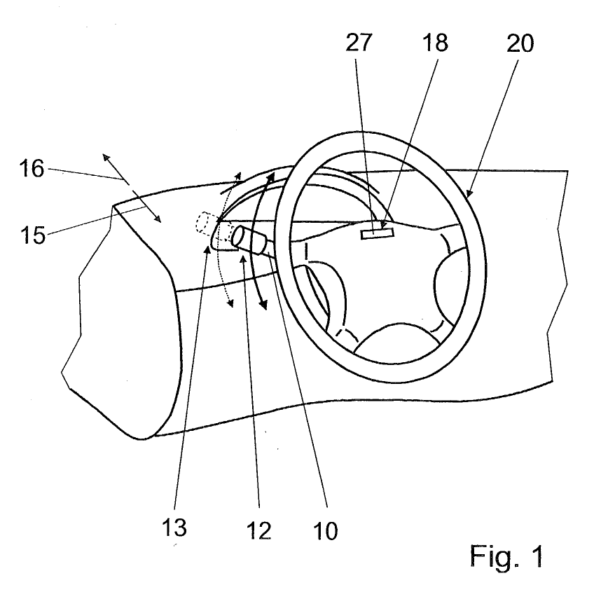

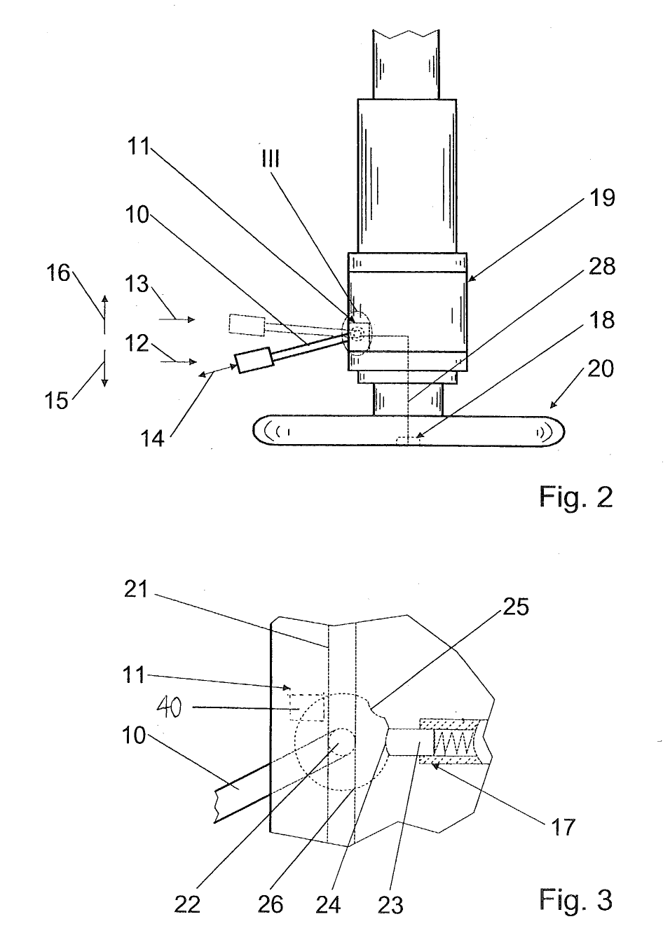

FIG. 1 shows a steering-column assembly function unit for a motor vehicle, which has a setting lever 10 which is mounted via a bearing unit 11 on a steering column 19 of a steering wheel 20 and can be held in a first initial position 12, from which the setting lever 10 can be actuated for control (FIGS. 1 and 2). According to certain preferred embodiments of the invention, the setting lever 10 can be held via the bearing unit 11 in a second initial position 13, from which the setting lever 10 can be actuated for control, the first initial position 12 being assigned to a parameter selection and the second initial position 13 to a system selection.

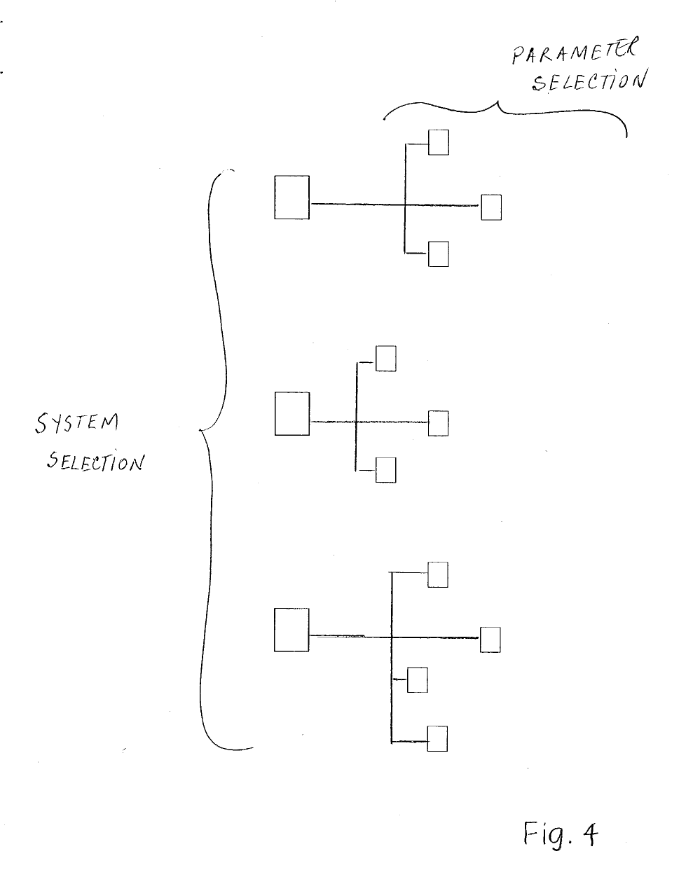

The setting lever 10 is mounted (FIG. 3) in the bearing unit 11 pivotably about an axis 21 running basically vertically and about a horizontal axis 22 running basically in the longitudinal direction of the motor vehicle, the setting lever 10 being capable of being changed over at its free end between the initial positions 12, 13 essentially perpendicularly to the direction of its extent 14, in the longitudinal directions 15, 16 of the motor vehicle.

The first initial position 12 is arranged so as to face an operator and the second initial position 13 is arranged so as to face away from the operator. The setting lever 10 is held in the initial positions 12, 13 in the longitudinal directions 15, 16 via the bearing unit 11 by a latching mechanism 17, and specifically, in the initial positions 12, 13, a spring-loaded latching bolt 23 engages into recesses 24, 25 of a latching disc 26 connected fixedly to the setting lever 10 and pivotably mounted, together with the latter, about the axis 22.

Furthermore, the bearing unit 11 has arranged in it a sensor 40, illustrated schematically, which detects the initial positions 12, 13 selected in each case and transmits a corresponding signal, via a signal line 28, to a signal unit 18 integrated in the steering wheel 20 and having a display 27.

In the second initial position 13, a list of controllable systems can be leafed through, specifically by an upward pivoting or tipping movement about the axis 21 upwards in the list and by a downward pivoting or tipping movement downwards in the list. After actuation, the setting lever 10 is always reset into its initial position 13. The selected system is indicated in the display 27.

When the operator has selected the desired system, for example a cruise control system or a speed-limiting system, he pivots the setting lever 10 about the axis 22 from the second initial position 13 into the first initial position 12. In the first initial position 12, the operator can control the correspondingly selected system, specifically by a downward or upward pivoting or tipping movement about the axis 21. After actuation, the setting lever 10 is always reset into its initial position 12. The setting level 10 is coupled to a signal unit 18 and at least one of the initial positions 12, 13 can be signalled via the signal unit 18.

Remaining degrees of freedom, such as in directions of rotation about a longitudinal axis of the setting lever 10, in the direction of extent 14 and, in the initial position 12, in the longitudinal direction 15 towards the operator or, in the initial position 13, in the longitudinal direction 16 facing away from the operator, can be utilized for control or for other functions which seem expedient to a person skilled in the art.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. Steering-column assembly function unit for a motor vehicle, comprising a setting lever which can be held via a bearing unit in a first initial position, from which the setting lever can be actuated for control, wherein the setting lever can be held via the bearing unit in at least one second initial position, from which the setting lever can be actuated for control, the first initial position being assigned to a parameter selection and the second initial position to a system selection.

2. Steering-column assembly function unit according to claim 1, wherein the setting lever is capable of being changed over at a free end between the initial positions approximately perpendicularly to the direction of extent.

3. Steering-column assembly function unit according to claim 2, wherein the setting lever is capable of being changed over between the initial positions approximately in the longitudinal directions of the motor vehicle.

4. Steering-column assembly function unit according to claim 3, wherein the first initial position is arranged so as to face an operator and the second initial position is arranged so as to face away from the operator.

5. Steering-column assembly function unit according to claim 1, wherein the setting lever is held in the initial positions via the bearing unit by a latching mechanism.

6. Steering-column assembly function unit according to claim 2, wherein the setting lever is held in the initial positions via the bearing unit by a latching mechanism.

7. Steering-column assembly function unit according to claim 3, wherein the setting lever is held in the initial positions via the bearing unit by a latching mechanism.

8. Steering-column assembly function unit according to claim 1, wherein the setting lever is coupled to a signal unit and at least one of the initial positions can be signalled via the signal unit.

9. A method of using a steering-column assembly function unit comprising utilizing the steering-column assembly function unit of claim 1.

10. A method of making a steering-column assembly function unit comprising making the steering-column assembly function unit of claim 1.

11. A method of making a steering-column assembly function unit for a motor vehicle, comprising:
providing a bearing unit, and
arranging a setting lever so that the setting lever can operatively be held in either a first initial position or a second initial position from which the setting lever can operatively be actuated for control,
wherein the first initial position is assigned to a parameter selection and the second initial position to a system selection.

12. A steering-column functional assembly, comprising:
a setting lever, and
a bearing unit which can hold the lever in a first or a second position,
wherein, in the first or second position, the setting lever is actuatable for control.

13. The steering-column functional assembly according to claim 12, wherein the first initial position is assigned to a parameter selection, and the second initial position is assigned to a system selection.

14. The steering-column functional assembly according to claim 13, wherein the setting lever is capable of being changed over at a free end between the initial positions approximately perpendicularly to the direction of extent.

15. The steering-column functional assembly according to claim 13, wherein the setting lever is capable of being changed over between the initial positions approximately in the longitudinal directions of the motor vehicle.

16. The steering-column functional assembly according to claim 12, wherein the setting lever is held in the initial positions via the bearing unit by a latching mechanism.

17. The steering-column functional assembly according to claim 12, wherein the setting lever is coupled to a signal unit and at least one of the initial positions can be signalled via the signal unit.
